(19) United States
(12) Patent Application Publication
(10) Pub. No.: US 2026/0187817 A1
(43) Pub. Date: Jul. 2, 2026

(54) INFORMATION PROCESSING APPARATUS, INFORMATION PROCESSING METHOD, AND NON-TRANSITORY RECORDING MEDIUM

(71) Applicant: NEC Corporation, Minato-ku, Tokyo (JP)

(72) Inventor: Yuta KUDO, Tokyo (JP)

(73) Assignee: NEC Corporation, Minato-ku, Tokyo (JP)

(21) Appl. No.: 18/858,800

(22) PCT Filed: Jul. 1, 2022
(86) PCT No.: PCT/JP2022/026457

§ 371 Date: Oct. 22, 2024

(51) Int. Cl. G06T 7/246

(52) U.S. Cl. CPC G06T 7/246

(57) ABSTRACT

An information processing apparatus includes: an acquisition unit that acquires an image; a tracking unit that tracks a person included in the image; and a registration updating unit that registers or updates feature information on a person who has been tracked by the tracking unit, and determines whether or not to register or update the feature information on the person, based on the image including the person.

### TECHNICAL FIELD

This disclosure relates to technical fields of an information processing apparatus, an information processing method, and a recording medium.

### BACKGROUND ART

Patent Literature 1 describes a technique/technology of: detecting, from a plurality of pieces of detection information in which a first detection target is periodically detected by each of a plurality of detection devices, a plurality of detection target positions that indicate the positions of the first detection target; converting the plurality of detection target positions into coordinates based on a space in which the plurality of detection devices are installed; storing first coordinates that represent a position at which the first detection target exists before being detected by the plurality of detection devices; acquiring, from a plurality of coordinates after conversion, coordinates after conversion into which the plurality of detection target positions detected from the detection information detected by a first time that is longer than the period have been converted, and extracting a plurality of second coordinates, from among the acquired coordinates after conversion, that are predicted to have a relationship with the first coordinates; and calculating representative coordinates on the basis of the plurality of second coordinates, and determining the representative coordinates as a position to which the first detection target has moved from the first coordinates. Patent Literature 2 describes a technique/technology of selecting an optimum image for authentication processing of a person, by performing first selection processing for detecting a person image from a video obtained by imaging and for selecting a best shot image from the images of the same person on the basis of a first index; calculating a confidence coefficient of the best shot image; performing second selection processing for selecting a best shot image from the images of the same person, according to a second index when the calculated confidence coefficient of the best shot image is lower than a first threshold; performing authentication processing of the person by using the best shot image selected by the first selection processing and a previously registered person image when the calculated confidence coefficient of the best shot image is greater than or equal to the first threshold; performing the authentication processing of the person by using the best shot image selected by second selection processing and the previously registered person image when the calculated confidence coefficient of the best shot image is lower than the first threshold; and displaying a result of the authentication processing of the person. Patent Literature 3 describes a technique/technology of tracking a plurality of objects by executing pixel change processing for performing a change to a pixel pattern where a feature of another tracking object is eliminated or reduced, on a processing object area in an image or an image area included in an image group, wherein the processing object area is determined based on a position determined as a correct or at a past time point for another tracking object other than one tracking object; and outputting the image or the image area subjected to the pixel change processing to a discriminator for learning and/or discrimination of one tracking object. Patent Literature 4 describes a technique/technology of tracking a plurality of moving objects by acquiring a plurality of frames; detecting an object from the plurality of frames; extracting, for the detected object, a first movement trajectory including a first frame, a second movement trajectory including only other frames before the first frame, and a third movement trajectory including only other frames after the first frame; and associating the second movement trajectory with the third movement trajectory when a degree of similarity between the second movement trajectory and the third movement trajectory is greater than or equal to a degree of similarity between the first movement trajectory and the third movement trajectory.

### CITATION LIST

### Patent Literature

Patent Literature 1: International Publication No. WO2019/155727
Patent Literature 2: JP2019-205002A
Patent Literature 3: JP2018-185724A
Patent Literature 4: JP2017-228303A

### SUMMARY

### Technical Problem

It is an example object of this disclosure to provide an information processing apparatus, an information processing method, and a recording medium that aim to improve the techniques/technologies disclosed in Citation List.

### Solution to Problem

An information processing apparatus according to an example aspect of this disclosure includes: an acquisition unit that acquires an image; a tracking unit that tracks a person included in the image; and a registration updating unit that registers or updates feature information on a person who has been tracked by the tracking unit, and determines whether or not to register or update the feature information on the person, based on the image including the person.

An information processing method according to an example aspect of this disclosure includes: acquiring an image; tracking a person included in the image; and determining whether or not to register or update feature information on the person, based on the image including the person, and registering or updating the feature information on a person who has been tracked.

A recording medium according to an example aspect of this disclosure is a recording medium on which a computer program that allows a computer to execute an information processing method is recorded, the information processing method including: acquiring an image; tracking a person included in the image; and determining whether or not to register or update feature information on the person, based on the image including the person, and registering or updating the feature information on a person who has been tracked.

### BRIEF DESCRIPTION OF DRAWINGS

FIG. 1 is a block diagram illustrating a configuration of an information processing apparatus according to a first example embodiment.

FIG. 2 is a block diagram illustrating a configuration of an information processing apparatus according to a second example embodiment.

FIG. 3 is a conceptual diagram illustrating an example of a scene in which the information processing apparatus according to the second example embodiment is applied.

FIG. 4 is a conceptual diagram illustrating an example of an information processing operation performed by the information processing apparatus according to the second example embodiment.

FIG. 5 is a flowchart illustrating a flow of a ReID matching operation performed by the information processing apparatus according to the second example embodiment.

FIG. 6 is a flowchart illustrating a flow of a registered feature updating operation performed by the information processing apparatus according to the second example embodiment.

FIG. 7 is a block diagram illustrating a configuration of an information processing apparatus according to a third example embodiment.

FIG. 8 is a flowchart illustrating a flow of a ReID matching operation performed by the information processing apparatus according to the third example embodiment.

FIG. 9 is a block diagram illustrating a configuration of an information processing apparatus according to a fourth example embodiment.

FIG. 10 is a flowchart illustrating a flow of a ReID matching operation performed by the information processing apparatus according to the fourth example embodiment.

FIG. 11 is a flowchart illustrating a flow of a registered feature updating operation performed by the information processing apparatus according to the fourth example embodiment.

FIG. 12 is a block diagram illustrating a configuration of an information processing apparatus according to a fifth example embodiment.

FIG. 13 illustrates a display example of a display in the fifth example embodiment.

### DESCRIPTION OF EXAMPLE EMBODIMENTS

Hereinafter, an information processing apparatus, an information processing method, and a recording medium according to example embodiments will be described with reference to the drawings.

### 1: First Example Embodiment

An information processing apparatus, an information processing method, and a recording medium according to a first example embodiment will be described. The following describes the information processing apparatus, the information processing method, and the recording medium according to the first example embodiment, by using an information processing apparatus 1 to which the information processing apparatus, the information processing method, and the recording medium according to the first example embodiment are applied.

### [1-1: Configuration of Information Processing Apparatus 1]

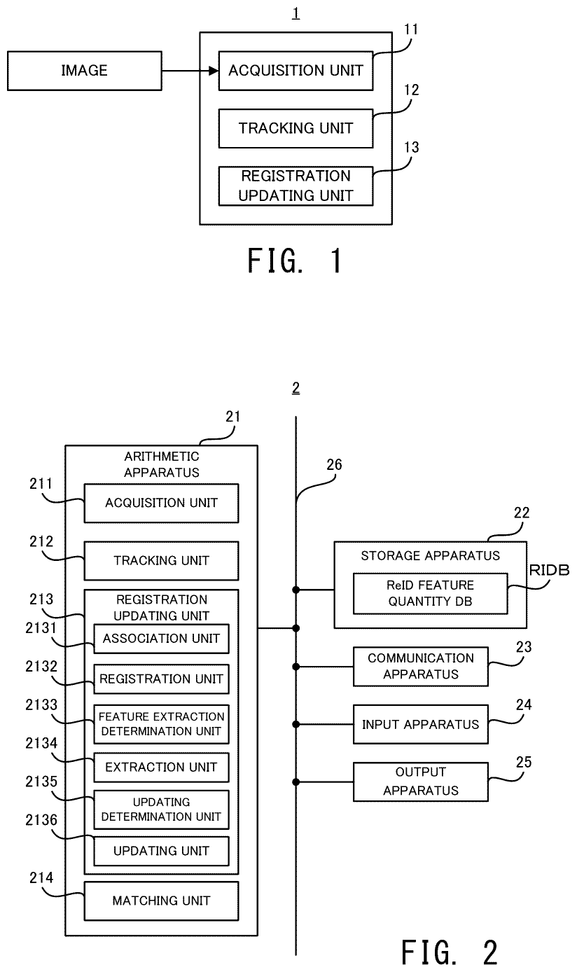

With reference to FIG. 1, a configuration of the information processing apparatus 1 according to the first example embodiment will be described. FIG. 1 is a block diagram illustrating the configuration of the information processing apparatus 1 according to the first example embodiment.

As illustrated in FIG. 1, the information processing apparatus 1 includes an acquisition unit 11, a tracking unit 12, and a registration updating unit 13. The acquisition unit 11 acquires an image. The tracking unit 12 tracks a person included in the image. The registration updating unit 13 determines whether or not to register or update feature information on the person, on the basis of the image including the person. The registration updating unit 13 registers or updates the feature information on the person who has been traced by the tracking unit 12.

### [1-2: Technical Effect of Information Processing Apparatus 1]

Since the information processing apparatus 1 according to the first example embodiment determines whether or not to register or update the feature information on the person who has been tracked by the tracking unit 12, a processing load is smaller than that when the determination is not performed. Furthermore, the information processing apparatus 1 updates the feature information on the person who has been tracked by the tracking unit 12, when it is determined to be updated. It is therefore possible to register more preferable feature information.

### 2: Second Example Embodiment

An information processing apparatus, an information processing method, and a recording medium according to a second example embodiment will be described. The following describes the information processing apparatus, the information processing method, and the recording medium according to the second example embodiment, by using an information processing apparatus 2 to which the information processing apparatus, the information processing method, and the recording medium according to the second example embodiment are applied.

### [2-1: Configuration of Information Processing Apparatus 2]

With reference to FIG. 2, a configuration of the information processing apparatus 2 according to the second example embodiment will be described. FIG. 2 is a block diagram illustrating the configuration of the information processing apparatus 2 according to the second example embodiment.

As illustrated in FIG. 2, the information processing apparatus 2 includes an arithmetic apparatus 21 and a storage apparatus 22. Furthermore, the information processing apparatus 2 may include a communication apparatus 23, an input apparatus 24, and an output apparatus 25. The information processing apparatus 2, however, may not include at least one of the communication apparatus 23, the input apparatus 24, and the output apparatus 25. The arithmetic apparatus 21, the storage apparatus 22, the communication apparatus 23, the input apparatus 24, and the output apparatus 25 may be connected through a data bus 26.

The arithmetic apparatus 21 includes at least one of a CPU (Central Processing Unit), a GPU (Graphics Processing Unit), and a FPGA (Field Programmable Gate Array), for example. The arithmetic apparatus 21 reads a computer program. For example, the arithmetic apparatus 21 may read a computer program stored in the storage apparatus 22. For example, the arithmetic apparatus 21 may read a computer program stored by a computer-readable and non-transitory recording medium, by using a not-illustrated recording medium reading apparatus provided in the information processing apparatus 2 (e.g., the input apparatus 24 described later). The arithmetic apparatus 21 may acquire (i.e., download or read) a computer program from a not-illustrated apparatus disposed outside the information processing apparatus 2, through the communication apparatus 23 (or another communication apparatus). The arithmetic apparatus 21 executes the read computer program. Consequently, a logical functional block for performing an operation to be performed by the information processing apparatus 2 is realized or implemented in the arithmetic apparatus 21. That is, the arithmetic apparatus 21 is allowed to function as a controller for realizing or implementing the logical functional block for performing an operation (in other words, processing) to be performed by information processing apparatus 2.

FIG. 2 illustrates an example of the logical functional block realized or implemented in the arithmetic apparatus 21 to perform an information processing operation. As illustrated in FIG. 2, an acquisition unit 211 that is a specific example of the “acquisition unit” described in Supplementary Note later, a tracking unit 212 that is a specific example of the “tracking unit” described in Supplementary Note later, a registration updating unit 213 that is a specific example of the “registration updating unit” described in Supplementary Note later, and a matching unit 214 that is a specific example of the “matching unit” described in Supplementary Note later, are realized or implemented in the arithmetic apparatus 21. The registration updating unit 213 may include an association unit 2131 that is a specific example of the “association unit” described in Supplementary Note later, a registration unit 2132 that is a specific example of the “registration unit” described in Supplementary Note later, a feature extraction determination unit 2133 that is a specific example of the “feature extraction determination unit” described in Supplementary Note later, an extraction unit 2134 that is a specific example of the “extraction unit” described in Supplementary Note later, an updating determination unit 2135 that is a specific example of the “updating determination unit” described in Supplementary Note later, and an updating unit 2136 that is a specific example of the “updating unit” described in Supplementary Note later. The matching unit 214, however, may not be realized or implemented in the arithmetic apparatus 21. Furthermore, the registration updating unit 213 may not include any one of the association unit 2131, the registration unit 2132, the feature extraction determination unit 2133, the extraction unit 2134, the updating determination unit 2135, and the updating unit 2136. Detailed operation of each of the acquisition unit 211, the tracking unit 212, the registration updating unit 213, and the matching unit 214 will be described later.

The storage apparatus 22 is configured to store desired data. For example, the storage apparatus 22 may temporarily store a computer program to be executed by the arithmetic apparatus 21. The storage apparatus 22 may temporarily store data that are temporarily used by the arithmetic apparatus 21 when the arithmetic apparatus 21 executes the computer program. The storage apparatus 22 may store data that are stored by the information processing apparatus 2 for a long time. The storage apparatus 22 may include at least one of a RAM (Random Access Memory), a ROM (Read Only Memory), a hard disk apparatus, a magneto-optical disk apparatus, a SSD (Solid State Drive), and a disk array apparatus. That is, the storage apparatus 22 may include a non-transitory recording medium. The storage apparatus 22 may store a ReID feature quantity database RIDB. In the second example embodiment, the ReID feature quantity database RIDB may be a database that associates a tracking ID with a ReID feature quantity on a one-to-one basis. The ReID feature quantity database RIDB will be described in detail with reference to Table 1. The storage apparatus 22, however, may not store the ReID feature quantity database RIDB.

The communication apparatus 23 is configured to communicate with an apparatus external to the information processing apparatus 2 through a not-illustrated communication network. When the storage apparatus 22 does not store the ReID feature quantity database RIDB, the ReID feature quantity database RIDB may be stored in an apparatus external to the information processing apparatus 2, and the communication apparatus 23 may exchange information with the ReID feature quantity database RIDB stored in the apparatus external to the information processing apparatus 2, through a communication network. The communication apparatus 23 may acquire an image from a camera CAM described later, through the communication network.

The input apparatus 24 is an apparatus that receives an input of information to the information processing apparatus 2 from an outside of the information processing apparatus 2. For example, the input apparatus 24 may include an operating apparatus (e.g., at least one of a keyboard, a mouse, and a touch panel) that is operable by an operator of the information processing apparatus 2. For example, the input apparatus 24 may include a reading apparatus that is configured to read information recorded as data on a recording medium that is externally attachable to the information processing apparatus 2.

The output apparatus 25 is an apparatus that outputs information to the outside of the information processing apparatus 2. For example, the output apparatus 25 may output information as an image. That is, the output apparatus 25 may include a display apparatus (a so-called display) that is configured to display an image indicating the information that is desirably outputted. For example, the output apparatus 25 may output information as audio/sound. That is, the output apparatus 25 may include an audio apparatus (a so-called speaker) that is configured to output audio/sound. For example, the output apparatus 25 may output information onto a paper surface. That is, the output apparatus 25 may include a print apparatus (a so-called printer) that is configured to print desired information on the paper surface.

### [2-2: Application Example of Information Processing Apparatus 2]

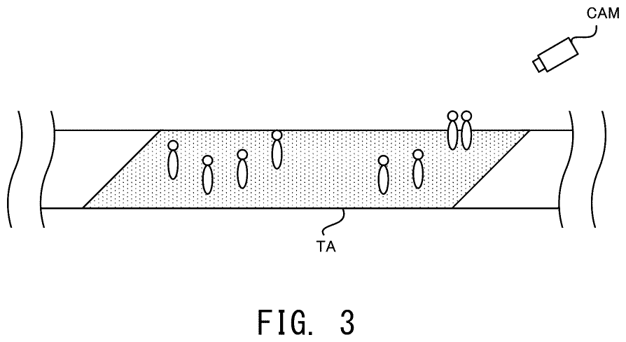

Next, with reference to FIG. 3, an application example of the information processing apparatus 2 in the second example embodiment will be described. FIG. 3 is a conceptual diagram illustrating an example of a scene in which the information processing apparatus 2 according to the second example embodiment is applied. The information processing apparatus 2 according to the second example embodiment may be used for real-time tracking of a person in marketing, entry/exit control, or the like. In addition, the real-time tracking of a person may be applied to “gateless authentication” in which an authentication subject keeps walking and is not aware of authentication.

The information processing apparatus 2 may track a person in a tracking area TA, as a tracking target. The tracking area TA may be, for example, an area of 5 meters by 5 meters. In the 5-meter wide, five to six persons can simultaneously pass through, and 20 to 30 persons may exist in the tracking area TA and may pass through the tracking area TA.

The camera CAM may image a predetermined space to capture a person. The camera CAM may be disposed to image an area including the tracking area TA. The camera CAM may be disposed at a height of, for example, 2.5 meters. When the camera CAM is disposed higher than a height of an average person, an image captured by the camera CAM tends to include a head area of a person and an upper body area of a person. The head area and the upper body area may be areas suitable for the tracking area of a person.

### [2-3: Tracking Operation]

The head area of a person is easily detected even when the person is facing other than forward, such as backwards or sideways. Even when many areas are hidden/covered by other people, the head area is often detected successfully. Therefore, in the second example embodiment, the tracking unit 212 may track the person on the basis of the head area of the person detected from the image.

The tracking unit 212 may detect and track the head area of a person passing through the tracking area TA. The tracking unit 212 may continue to track the person passing through the tracking area TA.

When detecting persons from the image, the tracking unit 212 may output positions of the head areas with which the tracking IDs are associated, by the number of the detected persons.

The tracking ID may not be an ID for identifying who the person is, but may be an ID for associating the same person in different images.

The image used by the tracking unit 212 for tracking may be one image frame of video data. That is, the acquisition unit 211 may sequentially acquire a plurality of image frames that constitute the video data as images.

The tracking performed by the tracking unit 212 may be an operation of associating the same person in a previous frame and a current frame. The tracking unit 212 may perform the tracking by determining the position of the head area in the image. In many cases, the movement of a person is small between previous and next frames, and a change in a head position is small. The tracking unit 212 may associate the same person on the basis of the position of the head area in the image. The tracking unit 212 may perform the tracking by determining identify of an image pattern of the head area, for example. In addition, the tracking unit 212 may perform the tracking by determining a degree of similarity of feature quantities extracted from the image of the head area. The tracking unit 212 may associate persons between frames by using an optical flow.

The tracking unit 212 may detect the upper body area including the head area of a person. Furthermore, the tracking unit 212 may detect an area above a knee of a person. In addition, the tracking unit 212 may detect area including main joints of a person.

### [2-4: ReID Operation]

In the tracking of a person, it is ideal to keep tracking the same person as the same person all the time; namely, it is ideal that the same person is associated with a single ID. In order to realize this, reconnection (ReID) through person re-identification is carried out.

The ReID may be an operation of associating and managing the tracking IDs of the person in question tracked in difference cases. The different cases may be different timings. In addition, the different cases may be different places. In addition, the different cases may be cases using images acquired from different cameras CAM.

When the tracking unit 212 hardly detects a tracking part of the person in question over a predetermined time, for example, for a second, it may be hard to track the person in question. That is, in a case where 30 frames are captured per second, when the tracking unit 212 hardly detects the tracking part over 30 frames, it may be hard to track the person in question. The ReID may be an operation performed when the operation of tracking a person is interrupted, when a new person appears, or in similar cases. Furthermore, the ReID may be a corresponding operation when a tracking error occurs due to covering/shielding or the like and a wrong tracking ID is given to the same person. The ReID may be an operation excellent in the determination of the same person. In the ReID, it may be determined whether or not to be the same person by ReID matching that matches the feature quantities extracted from the person. This feature quantity may be referred to as a ReID feature quantity.

The ReID feature quantity database RIDB may be a database in which the tracking ID of a person and the feature information on the person are registered in association with each other. The feature information may be the ReID feature quantity for determining whether or not to be the same person. The ReID feature quantity may be a feature quantity extracted from an image of a rectangular area including a person. The ReID feature quantity may be a feature quantity extracted from a full body image of the person in question. The ReID feature quantity may be a feature quantity extracted from an upper body image of the person in question. The upper body image of the person in question may include at least clothing worn by the person. That is, in the ReID, a person may be determined to be the same because the person wears the same clothes. The ReID feature quantity may be a feature quantity extracted from a head image including a head of the person in question. An image area from which the ReID feature quantity is extracted, may be referred to as a ReID feature quantity extraction area.

A matching operation using the ReID feature quantity may have a lighter operating load than that of the matching operation that allows individual identification such as face authentication. That is, the ReID may determine matching or mismatching of a person with higher accuracy than the tracking by the tracking unit 212, and may have a less operating load than that of the matching operation of identifying an individual. In the second example embodiment, even when the tracking by the tracking unit 212 is failed, the tracking may be continued by an operation having a less load than that of the operation that allows individual identification.

The matching operation performed by the matching unit 214 may be the ReID matching. The matching operation by the matching unit 214 may determine whether or not to be the same person with higher accuracy than that of the tracking operation by the tracking unit 212.

Due to the implementation of the ReID, even when the tracking is interrupted in real-time tracking of a person in the image, it is possible to connect the interrupted tracking. The ReID is a key technique/technology even in a case where the real-time tracking of a person is applied to the “gateless authentication” in which an authentication subject keeps walking and is not aware of authentication.

### [2-5: Information Processing Operation for Each Image]

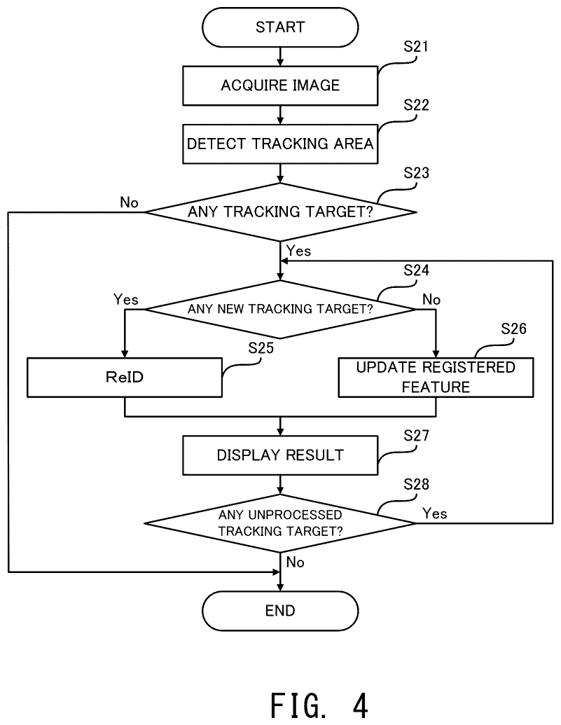

With reference to FIG. 4, a flow of an information processing operation performed by the information processing apparatus 2 according to the second example embodiment will be described. FIG. 4 is a flowchart illustrating the flow of the information processing operation performed by the information processing apparatus 2 according to the second example embodiment. The operation from “start” to “end” illustrated in FIG. 4 may be an operation for each frame.

As illustrated in FIG. 4, the acquisition unit 211 acquires an image (step S21). The acquisition unit 211 may sequentially acquire a plurality of image frames that constitute the video data. The tracking unit 212 detects the head area as the tracking area from a person included in the image (step S22).

The tracking unit 212 determines whether or not there is a tracking target (step S23). When there is a tracking target, the registration updating unit 213 tracks the person on the basis of the head area detected from the person included in the image.

When there is a tracking target (the step S23: Yes), the tracking unit 212 determines whether or not there is a new tracking target (step S24). When a tracking target for which the tracking is not continuous is included in the image, the tracking unit 212 may determine that the tracking target is a new tracking target.

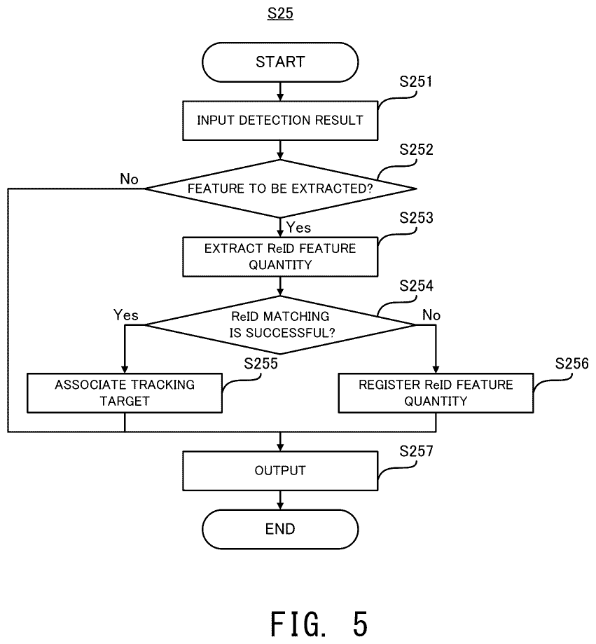

When there is a new tracking target (the step S24: Yes), the ReID operation is performed (step S25). Details of the ReID operation in the step S25 will be described later with reference to FIG. 5.

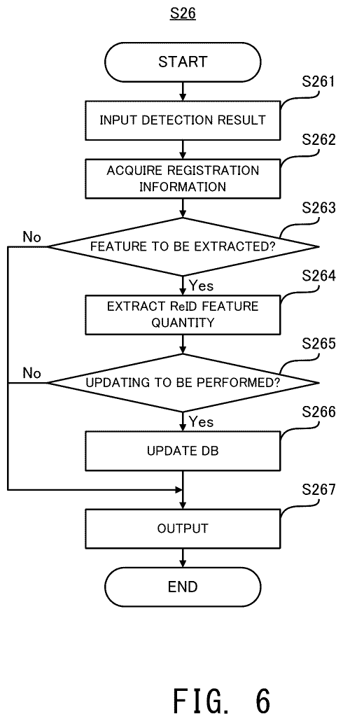

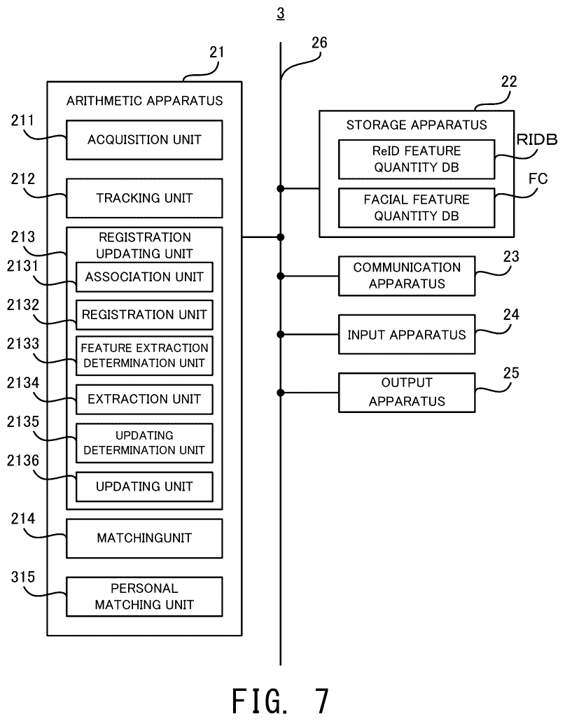

When there is no new tracking target (the step S24: No), a registered feature updating operation is performed (step S26). The registered feature updating operation in the step S26 will be described later with reference to FIG. 6.

After a ReID matching operation or the registered feature updating operation is ended, the operation proceeds to step S27. In the step S27, a result of the information processing operation is displayed. Details of the step S27 will be described in another example embodiment later.

The tracking unit 212 determines whether or not there is an un processed tracking target (step S28). When there is an unprocessed tracking target (the step S28: Yes), the operation proceeds to the step S24. When there is no tracking target in the step S23 and when there is no unprocessed tracking target, the information processing operation for each image is ended.

### [Step S25: ReID Matching Operation]

As illustrated in FIG. 5, the feature extraction determination unit 2133 inputs a detection result (step S251). The detection result may include an image area of the person included in the image.

The feature extraction determination unit 2133 determines whether to extract the ReID feature quantity serving as the feature information on the person in question (step S252). The feature extraction determination unit 2133 may determine whether or not to extract the ReID feature quantity on the basis of the number of images (also referred to as the “number of tracking frames”) in which the tracking unit 212 detects the head area as the same tracking target. The feature extraction determination unit 2133 may determine whether or not to extract the ReID feature quantity on the basis of whether or not the number of tracking frames of the tracking target exceeds a first threshold. For example, the feature extraction determination unit 2133 may determine that the ReID feature quantity is to be extracted when the number of frames in which the tracked person in question is detected exceeds 15. For example, in a case where 30 frames are captured per second, the feature extraction determination unit 2133 may determine that the ReID feature quantity is to be extracted 0.5 seconds after a new start of the tracking. Alternatively, the feature extraction determination unit 2133 may determine that the ReID feature quantity is to be extracted when the position in the image with the person detected is not an end of the image. This is because when the person is detected at the edge of the image, the person may not be included in the image in the subsequent frames and may no longer be the tracking target. Alternatively, the feature extraction determination unit 2133 may determine that the ReID feature quantity is to be extracted when the ReID feature quantity extraction area of the person included in the image has predetermined or higher quality. The case where the ReID feature quantity extraction area in the image has predetermined or higher quality, may be a case of quantity that allows a feature quantity appropriate for the ReID matching to be extracted from the ReID feature quantity extraction area in the image.

When it is determined that the ReID feature quantity is not to be extracted (the step S252: No), the registration unit 2132 may register, for the person in question, a temporary ID “N” before ReID processing in the ReID feature quantity database RIDB illustrated in Table 1 below.

TABLE 1
[ReID Feature Quantity Database RIDB]

| | | ReID FEATURE | EVALUATION | REGISTERED |
|---|---|---|---|---|
| TRACKING ID | TRACKED ID | QUANTITY | VALUE | IMAGE |
| B | — | B B B | 3 | B - k |
| C | — | C C C | 4 | C - l |
| N | — | — | — | — |

As illustrated in the Table 1, the ReID feature quantity database RIDB may include a column of the tracking ID, a column of a tracked ID, a column of the ReID feature quantity, a column of an evaluation value of the ReID feature quantity, and a column of information indicating an image (also referred to as a “registered image”) in which the ReID feature quantity is extracted.

When it is determined that the ReID feature quantity is to be extracted (the step S252: Yes), the matching unit 214 extracts the ReID feature quantity (step S253). The matching unit 214 matches the extracted ReID feature quantity with a registered ReID feature quantity registered in the ReID feature quantity database RIDB, and determines whether or not the matching is successful (step S254). The matching unit 214 may calculate a matching score between the extracted ReID feature quantity and each of all the registered ReID feature quantities. The matching unit 214 may determine that the matching is successful when a maximum matching score of the calculated matching scores is greater than a second threshold. The matching unit 214 may determine that a tracking target corresponding to the registered ReID feature quantity in which the maximum matching score is calculated, is the same person as the tracking target in question. That is, when the ReID feature quantity serving as the feature information on a person who is the same as a newly tracked person is registered in the ReID feature quantity database RIDB, the registration unit 2132 associates the person with a registered person.

When the matching is successful (the step S254: Yes), the association unit 2131 associates the new tracking target with the registered tracking target (step S255). For example, when it is determined that a person is the same as a person with the tracking ID tracked in the past, the association unit 2131 may update the ReID feature quantity database RIDB illustrated in Table 1, to the ReID feature quantity database RIDB illustrated in Table 2.

TABLE 2
[ReID Feature Quantity Database RIDB Updated in in Step S255]

| | | ReID FEATURE | EVALUATION | REGISTERED |
|---|---|---|---|---|
| TRACKING ID | TRACKED ID | QUANTITY | VALUE | IMAGE |
| B | — | B B B | 3 | B - k |
| C | — | C C C | 4 | C - l |
| N | A | A A A | 5 | A - n |

That is, the column of the tracked ID may be updated with “A”, the column of the ReID feature quantity may be updated with “AAA”, the column of the evaluation value of the ReID feature quantity may be updated with “5”, and the column of the information indicating the registered image may be updated with “A-n”. “AAA” is a ReID feature quantity of “A”, “5” is an evaluation value of “AAA”, and “A-n” may be information indicating an image in which “AAA” is extracted.

When the matching is failed (the step S24: No), the registration unit 2132 registers the ReID features of the new tracking target (step S256). For example, the registration unit 2132 may update the ReID feature quantity database RIDB illustrated in Table 1, to the ReID feature quantity database RIDB illustrated in Table 3.

TABLE 3
[ReID Feature Quantity Database RIDB Updated in Step S256]

| | | ReID FEATURE | EVALUATION | REGISTERED |
|---|---|---|---|---|
| TRACKING ID | TRACKED ID | QUANTITY | VALUE | IMAGE |
| B | — | B B B | 3 | B - k |
| C | — | C C C | 4 | C - l |
| D | — | D D D | 5 | D - m |

That is, the column of the tracking ID may be updated with “D”, the column of the ReID feature quantity may be updated with “DDD”, the column of the evaluation value of the ReID feature quantity may be updated with “5”, and the column of the information indicating the registered image may be updated with “D-m”. “DDD” is a ReID feature quantity extracted in the step S253, “5” is an evaluation value of “DDD”, and “D-m” may be information indicating an image in which “DDD” is extracted, i.e., information indicating the image acquired in the step S251.

The registration updating unit 213 outputs a result of the ReID operation (step S257).

### [Step S26: Registered Feature Updating Operation]

As illustrated in FIG. 6, the feature extraction determination unit 2133 inputs a detection result (step S261). The detection result may include an image area of the person included in the image.

The feature extraction determination unit 2133 acquires registered information on the tracking target (step S262). The feature extraction determination unit 2133 may acquire the number of tracking frames of the tracked target, the evaluation value of the registered image, and the registered image. The feature extraction determination unit 2133 determines whether or not to extract the ReID feature quantity (step S263). Details of the step S263 will be described later.

The extraction unit 2134 extracts the ReID feature quantity from the ReID feature quantity extraction area of the person (step S264). The ReID feature quantity extraction area may be an upper body, above the knee.

The updating determination unit 2135 determines whether to update the ReID feature quantity (step S265). Details of the step S265 will be described later.

The updating unit 2136 updates the ReID feature quantity (step S266). Even in the updating, the updating unit 2136 does not need to discard the previously registered ReID feature quantity, evaluation value, and registered image. The previously registered ReID feature quantity, evaluation value, and registered image may be used to calculate the evaluation value.

The registration updating unit 213 outputs a result of the registered feature updating operation (step S267).

### [Determination in Step S263]

In the step S263, on the basis of at least any one of the followings (1) to (3), the feature extraction determination unit 2133 may determine whether or not to extract the feature information on the person in question.

### (1) Number of Tracking Frames

The feature extraction determination unit 2133 may determine whether or not to extract the ReID feature quantity serving as the feature information on the person in question, on the basis of the number of tracking frames. The feature extraction determination unit 2133 may determine whether or not to extract the ReID feature quantity on the basis of whether or not the number of tracking frames of the tracking target exceeds a first threshold. For example, the feature extraction determination unit 2133 may determine that the ReID feature quantity is to be extracted when the number of frames in which the person in question tracked by the tracking unit 212 is detected exceeds 15. For example, in a case where 30 frames are captured per second, the feature extraction determination unit 2133 may determine that the ReID feature quantity is to be extracted 0.5 seconds after a new start of the tracking.

### (2) Information Indicating Predetermined Joint (Referred to as “Visible Joint Point”) of Person Included in Image

By determining the visible joint point, it is possible to determine how much area of a person is included in the image with a small processing load. The feature extraction determination unit 2133 may determine whether a particular joint of a person is included in the image. The particular joint may include facial parts such as an eye and a nose, a neck, a shoulder, an elbow, a wrist, a waist, a knee, an ankle, and the like. The particular joint may be a joint above the knee. The ReID feature quantity extraction area may be determined to overlap with at least one of the head of the person and the torso of the person. That is, in the image from which the ReID feature quantity is extracted, a face of the person may be hidden/covered, and the ReID feature quantity may be determined to be extracted from an image including below the neck of the person.

The feature extraction determination unit 2133 may perform the determination based on an overlap between the visible joint point in the registered image and the visible joint point in the acquired image (current frame). When the overlap between the visible joint point in the registered image and the visible joint point in the acquired image (current frame) is greater than a third threshold, the feature extraction determination unit 2133 may determine that the feature information on the person in question is to be extracted.

The registered image is a registered image in which the ReID feature quantity is extracted and is an image having predetermined or higher quality. Therefore, it may be considered to be an image suitable for feature extraction, when there is a large overlap between the visible joint points in the registered image and the visible joint points in the acquired image (current frame). The third threshold may be determined to overlap with 50% or more of area of an entire body of the person in question, for example.

The feature extraction determination unit 2133 may determine that the feature information on the person in question is to be extracted, for example, when a value calculated by the following Equation 1 is greater than the third threshold.

$$S = \frac{{J}_{visible}^{1} ⋂ {J}_{visible}^{2}}{{J}_{visible}^{1} ⋃ {J}_{visible}^{2}} \times \frac{{s}_{visible}^{1} + {s}_{visible}^{2}}{2} \qquad [ Equation 1 ]$$

J_{visible} may be a set of visual joint points. S_{visible} may be an estimated score of the outputted visible joint point. “1” in the right shoulder indicates a current frame, and “2” may indicate a previous frame. By taking into account the estimated score, the feature extraction determination unit 2133 is capable of properly determining whether or not to be further suitable for feature extraction.

### (3) Evaluation Value of ReID Feature Quantity

The feature extraction judgment unit 2133 may determine whether to update the ReID feature quantity database RIDB, by calculating the evaluation value of the ReID feature quantity registered in the ReID feature quantity database RIDB. For example, when the evaluation value of the registered ReID feature quantity is less than a fourth threshold, the feature extraction determination unit 2133 may determine that the feature information on the person in question is to be extracted. That is, the feature extraction determination unit 2133 may determine to update the ReID feature quantity database RIDB when the registered ReID feature quantity is not preferable. The calculation of the evaluation value of the ReID feature quantity will be described in detail in the subsequent description of the step S265.

By the feature extraction determination unit 2133 determining whether or not to extract the ReID feature quantity on the basis of a tracking history of the tracking target, the registered information or the like, it is possible to reduce a calculation time.

### [Determination in Step S265]

The updating determination unit 2135 may determine whether or not to update the registered feature information on the basis of the evaluation value of the ReID feature quantity extracted by the extraction unit 2134. The updating determination unit 2135 may update the ReID feature quantity when the evaluation value of the ReID feature quantity extracted by the extraction unit 2134 exceeds the evaluation value of the ReID feature quantity registered in the ReID feature quantity database RIDB. The updating determination unit 2135 may calculate the evaluation value by any one of the following methods (i) to (iv).

(i) The updating determination unit 2135 may calculate the evaluation value on the basis of information indicating the overlap between the visible joint point in the registered image and the visible joint point in the acquired image. The information indicating the overlap between the predetermined joint part of the person in the registered image and the predetermined joint part of the person in the image may be the same as the information described in (2) of the step S263. The updating determination unit 2135 may perform calculation using all the registered images of the tracking target registered in the past, and may adopt a maximum value as the evaluation value.

(ii) The updating determination unit 2135 may evaluate the extracted ReID feature quantity on the basis of a result of the matching between the extracted ReID feature quantity and the registered ReID feature quantity, and may calculate the evaluation value. The updating determination unit 2135 may perform calculation using all the ReID feature quantities of the tracking target registered in the past, and may adopt a maximum value as the evaluation value.

(iii) The updating determination unit 2135 may calculate the evaluation value using a machine-learned calculation model. The calculation model may be a calculation model machine-learned by using a relation between the evaluation value by (i) and the evaluation value by (ii). The calculation model may be a calculation model that estimates the evaluation value of the extracted ReID feature quantity when a result of the matching between the information indicating the overlap of the visible joint points and the ReID feature quantity is inputted. The calculation model may be a machine-learnable calculation model, and an example of the machine-learnable calculation model may be a convolutional neural network.

(iv) The updating determination unit 2135 may evaluate the extracted ReID feature quantity on the basis of at least one of information indicating an overlap between first predetermined areas of a person in different images and information indicating an overlap between second predetermined areas of different persons in the same image, and may calculate the evaluation value. Each of the first predetermined area and the second predetermined area may be the ReID feature quantity extraction area. The updating determination unit 2135 may calculate the evaluation value on the basis of an overlap index of the ReID feature quantity extraction area. The updating determination unit 2135 may use IoU (Intersection over Union) and may calculate the evaluation value using the following Equation 2.

IoU with the same tracing target in different images×(1−IoU with another tracing target in a current image) [Equation 2]

To the image acquired by the acquisition unit 211, information about the person included in the image may be added. This information may include information indicating the tracking area of the person included in the image. In this case, the camera CAM may perform detection of the person and detection of the tracking area of the person, in addition to the imaging. That is, a part of the operation of the tracking unit 212 described above may be performed outside the information processing apparatus 2.

### [2-6: Technical Effect of Information Processing Apparatus 2]

In the ReID matching of the person, the accuracy of the ReID matching can be improved, depending on which feature quantity is used for matching, i.e., which feature quantity is registered. Since the information processing apparatus 2 according to the second example embodiment selects the image for feature extraction and further selects the feature information to be registered and updated, it is possible to adopt better features while ensuring a real-time performance. This improves the accuracy of the ReID matching and improves a tracking result.

For example, in a first frame in which a new tracking target appears, an area in which the tracking target in question is not hidden/covered is often small. In contrast, since the information processing apparatus 2 determines whether or not to extract the feature information on the basis of the number of tracking frames, it is possible to determine whether or not good feature information can be extracted in the image, without extracting the feature information. Furthermore, since the information processing apparatus 2 determines whether or not to extract the feature information on the basis of the visible joint point, it is possible to determine whether or not good feature information can be extracted in the image, without extracting the feature information. In addition, since the information processing apparatus 2 determines whether or not to update the ReID feature quantity database RIDB on the basis of the evaluation value of the feature information, the feature information with a higher evaluation value is registered, and it is possible to perform good ReID matching using the registration feature information. Furthermore, since the information processing apparatus 2 performs the determination based on the result of the matching with the registered feature information that is already determined to be suitable for the ReID matching, it is possible to determine whether or not the feature information is good. Furthermore, since the information processing apparatus 2 performs the determination based on the overlap between the tracking target in question in the previous frame and the tracking target in question in the current frame and the overlap between the tracking target in question in the current frame and a tracking target other than the tracking target in question in the current frame, it is possible to update the ReID feature quantity database RIDB by using the feature information extracted from the tracking target in question who is less hidden/covered.

### 3: Third Example Embodiment

An information processing apparatus, an information processing method, and a recording medium according to a third example embodiment will be described. The following describes the information processing apparatus, the information processing method, and the recording medium according to the third example embodiment, by using an information processing apparatus 3 to which the information processing apparatus, the information processing method, and the recording medium according to the third example embodiment are applied.

The information processing apparatus 3 according to the third example embodiment may be applied when face authentication is performed while tracking a moving person. In this instance, the camera CAM may be a 4K camera and may be capable of capturing a high-quality image that may be used for the face authentication.

### [3-1: Configuration of Information Processing Apparatus 3]

With reference to FIG. 7, a configuration of the information processing apparatus 3 according to the third example embodiment will be described. FIG. 7 is a block diagram illustrating the configuration of the information processing apparatus 3 according to the third example embodiment.

As illustrated in FIG. 7, the information processing apparatus 3 according to the third example embodiment is different from the information processing apparatus 2 according to the second example embodiment, in that the arithmetic apparatus 21 further includes a personal matching unit 315 and the storage apparatus 22 further includes a facial feature quantity database FC. The personal matching unit 315 collects biometric information on the person included in the image, and matches the biometric information with registered biometric information. The facial feature quantity database FC stores a registration ID of a registered person and the biometric information on the registered person in association with each other. The facial feature quantity database FC may store the registration ID of the registered person and the feature quantity extracted from the biometric information on the registered person in association with each other. When the facial feature quantity database FC is not stored in the storage apparatus 22, the facial feature quantity database FC may be stored in an apparatus external to the information processing apparatus 3, and the communication apparatus 23 may exchange information with the facial feature quantity database FC stored in the apparatus external to the information processing apparatus 3, through the communication network. Other features of the information processing apparatus 3 may be the same as those of the information processing apparatus 2. For this reason, a part that is different from each of the example embodiments described above will be described in detail below, and a description of the other overlapping parts will be omitted as appropriate.

### [3-2: Facial Feature Quantity Database FC]

For example, the facial feature quantity database FC in the third example embodiment may be configured as illustrated in [Table 4] below.

TABLE 4
[Facial Feature Quantity Database FC]

| | | | FACIAL |
|---|---|---|---|
| | ReID FEATURE | PERSONAL | FEATURE |
| TRACKING ID | QUANTITY | ID | QUANTITY |
| A | A A A | a | a a a |
| B | — | b | b b b |

That is, the facial feature quantity database FC may include a column of the tracking ID, a column of the ReID feature quantity, a column of a personal ID, and a column of the facial feature quantity. The personal ID may be an ID for identifying who the person is, and may be an ID of the person who is identified.

### [3-3: ReID Matching Operation Performed by Information Processing Apparatus 3]

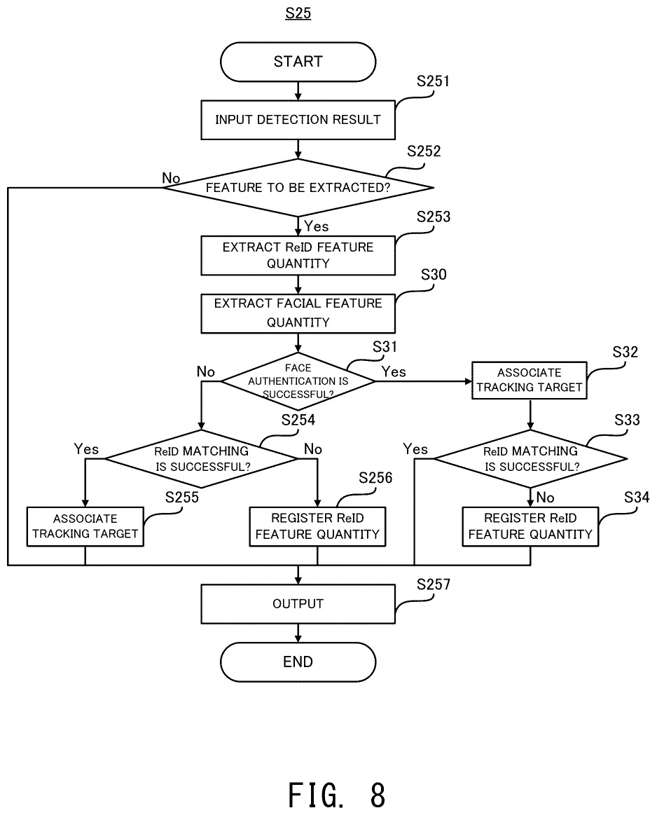

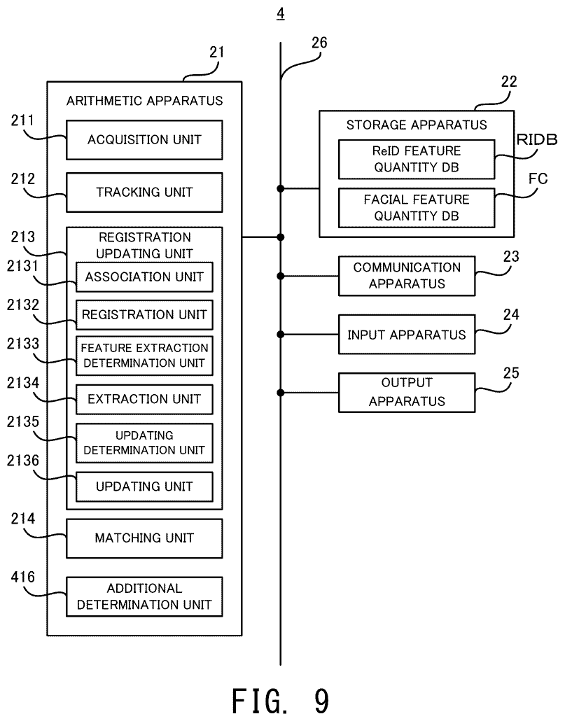

The information processing apparatus 3 according to the third example embodiment is different from the information processing apparatus 2 according to the second example embodiment, in the ReID matching operation in the step S25 in FIG. 4. Therefore, with reference to FIG. 8, a flow of a ReID matching operation performed by the information processing apparatus 3 according to the third example embodiment will be described. FIG. 8 is a flowchart illustrating the flow of the ReID matching operation performed by the information processing apparatus 3 according to the third example embodiment. The operation from “start” to “end” illustrated in FIG. 4 may be an operation regarding a single tracking target.

As illustrated in FIG. 8, the feature extraction determination unit 2133 inputs a detection result (step S251). The feature extraction determination unit 2133 determines whether to extract the ReID feature quantity serving as the feature information on the person in question (step S252).

When it is determined that the ReID feature quantity is to be extracted (the step S252: Yes), the matching unit 214 extracts the ReID feature quantity (step S253). The personal matching unit 315 collects a face image serving as the biometric information on the person included in the image, and extracts a feature quantity of the face image (sometimes referred to as a “facial feature quantity”) from the face image (step S30).

The personal matching unit 315 matches the extracted facial feature quantity with a facial feature quantity registered in the facial feature quantity database FC, and determines whether or not the matching is successful (step S31). The matching of the facial feature quantities by the personal matching unit 315 may be an operation of identifying an individual.

When the matching of the facial feature quantities is successful (the step S31: Yes), the association unit 2131 associates the person included in the image with a person corresponding to the registered biometric information (step S32). The matching unit 214 matches the extracted ReID feature quantity with all the registered ReID feature quantities registered in the ReID feature quantity database RIDB, and determines whether or not the matching is successful (step S33).

When the matching is failed (the step S33: No), the association unit 2131 registers an extracted matching feature of the new tracking target as a registered matching feature (step S34). For example, when the new tracking target is the same as a person with a tracking ID “B” illustrated in Table 4, the facial feature quantity is registered in the facial feature quantity database FC, but the ReID feature quantity is not registered. Therefore, the determination is Yes in the step S31 and the determination is No in the step S33. On the other hand, for example, when the new tracking target is the same as a person with a tracking ID “A” illustrated in Table 4, the facial feature quantity and the ReID feature quantity are registered in the facial feature quantity database FC. Therefore, the determination is Yes in the step S31 and the determination is also Yes in the step S33.

When the matching of the facial feature quantities is failed (the step S31: No), the matching unit 214 matches the extracted ReID feature quantity with all the registered ReID feature quantities registered in the ReID feature quantity database RIDB, and determines whether or not the matching is successful (step S254). The case where the facial matching is failed, may be a case where the face image of the person is not registered. That is, the person who is the tracking target may be a person who is not yet authenticated in the tracking area TA. When the matching is successful (the step S254: Yes), the registration unit 2132 associates the person included in the image with the person corresponding to the registered ReID feature quantity (step S255). When the matching is failed (the step S254: No), the association unit 2131 registers the ReID feature quantity of the new tracking target as the registered matching feature (step S256). The registration updating unit 213 outputs a result of the ReID matching operation (step S257).

In the registered feature updating operation in the third example embodiment, when the face image suitable for extracting the facial feature quantity is included in the image, the facial feature quantity may be updated with the consent of the person in question. A person whose facial feature quantity is already registered, is a person who is registered and identified. Therefore, a notification to ask the person whether to permit the updating, may be transmitted to a device such as a smartphone carried by the person, to obtain the consent, for example. Alternatively, in a case where the facial feature quantity worth updating can be extracted in entering the tracking area TA, the consent to the updating may be obtained. Even in this case, a notification indicating the updating may be transmitted to the device such as a smartphone carried by the person.

The present example embodiment exemplifies and describes the case where the personal matching unit 315 collects the face image as the biometric information and performs the matching of the facial feature quantities, but the personal matching unit 315 may collect another type of biometric information, e.g., iris image, and may perform matching of the feature quantities extracted from the iris image.

### [3-4: Technical Effect of Information Processing Apparatus 3]

Since the information processing apparatus 3 according to the third example embodiment associates the tracking target by using the biometric information, it is possible to associate the tracking target with high accuracy.

### 4: Fourth Example Embodiment

An information processing apparatus, an information processing method, and a recording medium according to a fourth example embodiment will be described. The following describes the information processing apparatus, the information processing method, and the recording medium according to the fourth example embodiment, by using an information processing apparatus 4 to which the information processing apparatus, the information processing method, and the recording medium according to the fourth example embodiment are applied.

### [4-1: Configuration of Information Processing Apparatus 4]

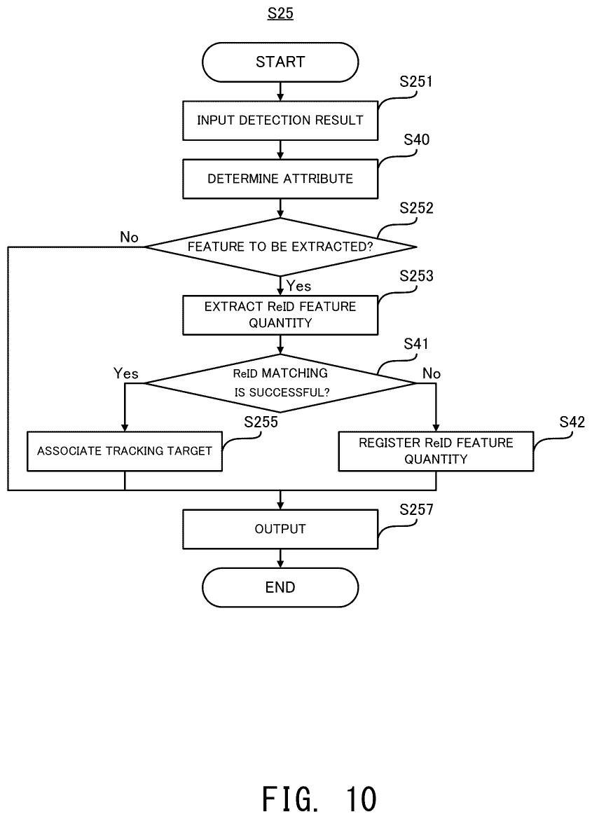

With reference to FIG. 9, a configuration of the information processing apparatus 4 according to the fourth example embodiment will be described. FIG. 9 is a block diagram illustrating the configuration of the information processing apparatus 4 according to the fourth example embodiment.

As illustrated in FIG. 9, the information processing apparatus 4 according to the fourth example embodiment is different from the information processing apparatus 2 according to the second example embodiment and the information processing apparatus 3 according to the third example embodiment, in that the arithmetic apparatus 21 includes an additional determination unit 416. Other features of the information processing apparatus 4 may be the same as those of the information processing apparatus 2 or the information processing apparatus 3. For this reason, a part that is different from each of the example embodiments described above will be described in detail below, and a description of the other overlapping parts will be omitted as appropriate.

[4-2: Information processing Operation Performed by Information Processing Apparatus 4]

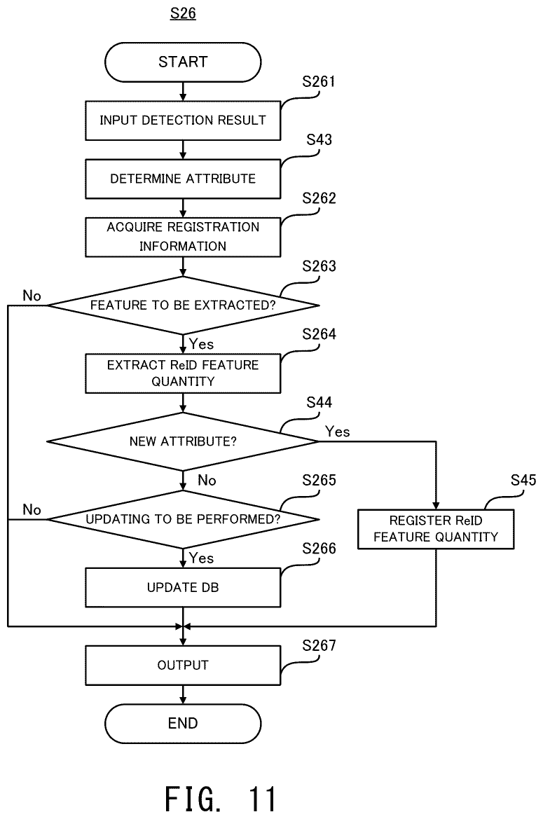

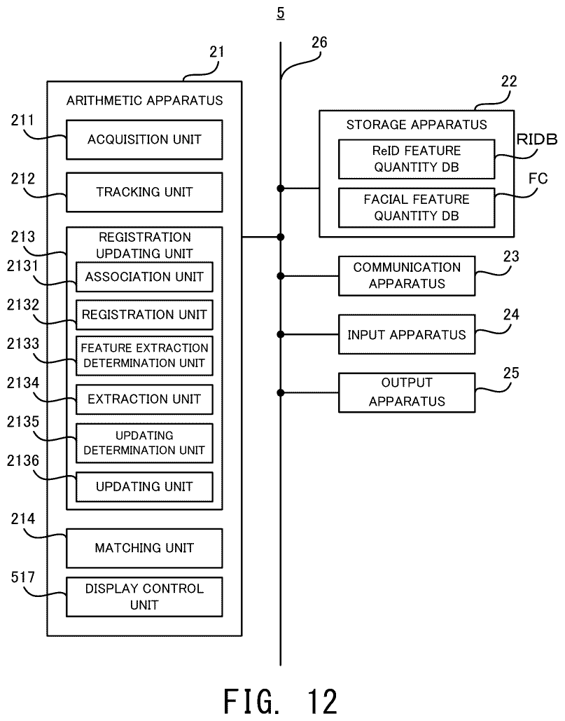

With reference to FIG. 10 and FIG. 11, a flow of an information processing operation performed by the information processing apparatus 4 according to the fourth example embodiment will be described. FIG. 10 is a flowchart illustrating a flow of a ReID matching operation performed by the information processing apparatus 4 according to the fourth example embodiment. FIG. 11 is a flowchart illustrating a flow of a registered feature updating operation performed by the information processing apparatus 4 according to the fourth example embodiment. The operations from “start” to “end” illustrated in FIG. 10 and FIG. 11 may be those regarding a single tracking target.

As illustrated in FIG. 10, the feature extraction determination unit 2133 inputs a detection result (step S251).

The addition determination unit 416 determines to which of a plurality of predetermined attributes the person included in the image corresponds (step S40). The plurality of predetermined attributes may be, for example, a direction of the body of the person. There are differences among the feature quantity that can be extracted from an image of the person captured from the front, the feature quantity that can be extracted from an image of the person captured from the side, and the feature quantity that can be extracted from an image of the person captured from the back. When the plurality of predetermined attributes is the direction of the body of the person, the addition determination unit 416 may determine the direction of the person included in the image.

The feature extraction determination unit 2133 determines whether to extract the ReID feature quantity of the person in question (step S252). When it is determined that the ReID feature quantity is to be extracted (the step S252: Yes), the matching unit 214 extracts the ReID feature quantity (step S253).

The matching unit 214 matches the extracted ReID feature quantity, with the registered ReID feature quantity of the attribute determined in the step S40 registered in the ReID feature quantity database RIDB, and determines whether or not the matching is successful (step S41).

### [4-3: ReID Feature Quantity Database RIDB]

For example, the ReID feature quantity database RIDB according to the fourth example embodiment may be configured as illustrated in [Table 5] below.

TABLE 5
[ReID Feature Quantity Database RIDB]

| | FRONT ReID | SIDE ReID | BACK ReID |
|---|---|---|---|
| | FEATURE | FEATURE | FEATURE |
| TRACKING ID | QUANTITY | QUANTITY | QUANTITY |
| A | A A A | — | A A A A |
| B | B B B | — | — |

That is, the ReID feature quantity database RIDB according to the fourth example embodiment may include a column of the tracking ID, a column of a front ReID feature quantity, a column of a side ReID feature quantity, and a column of a back ReID feature quantity. In the ReID feature quantity database RIDB according to the fourth example embodiment, the ReID feature quantities of the plurality of attributes may be registered.

When the matching is successful (the step S254: Yes), the registration unit 2132 associates the new tracking target with the registered tracking target (step S255). For example, when the attribution of the person included in the image is “back” and the person in question is the same as the person with the tracking ID “A”, there is the back ReID feature quantity. Therefore, the matching is successful.

When the matching is failed (the step S41: No), the ReID feature quantity corresponding to the attribute in question is not registered, and the registration unit 2132 thus registers the ReID feature quantity extracted as the feature information on the attribute in question (step S42). When the attribute of the person included in the image is “back” and the person is the same as the person with the tracking ID “B”, back ReID feature quantity. Therefore, the matching is failed. In the case illustrated in Table 5, the back ReID feature quantity of the tracking ID “B” may be updated from “-” to “BBBB” in the step S42.

The registration updating unit 213 outputs a result of the ReID matching operation (step S257).

As illustrated in FIG. 11, the feature extraction determination unit 2133 inputs a detection result (step S261). The addition determination unit 416 determines to which of the plurality of predetermined attributes the person included in the image corresponds (step S43). The feature extraction determination unit 2133 acquires registered information on the tracking target (step S262). The feature extraction determination unit 2133 determines whether or not to extract the ReID feature quantity (step S263). The extraction unit 2134 extracts a matching feature from a predetermined area of the person (step S264).

The additional determination unit 416 determines whether or not the attribute determined in the step S43 is a new attribute (step S44). The additional determination unit 416 may determine whether or not the attribute is new, by determining whether or not the ReID feature quantity corresponding to the attribute is registered. When the column corresponding to the attribute is “-”, the additional determination unit 416 may determine that the attribute is new.

When the attribute is not a new attribute and the ReID feature quantity corresponding to the attribute is registered (the step S44: No), it is determined whether or not the registered ReID feature quantity of the person is updated (step S265). When it is determined that the ReID feature quantity is to be updated, the updating unit 2136 updates the ReID feature quantity (step S266).

When the ReID feature quantity corresponding to the attribute is not registered and the attribute is a new attribute (the step S44: Yes), the registration unit 2132 registers the feature information corresponding to the attribute in question (step S45).

The registration updating unit 213 outputs a result of the registered feature updating operation (step S267).

The present example embodiment exemplifies and describes the direction of the body of the person as the plurality of predetermined attributes, but the plurality of predetermined attributes may be, for example, an area of a person who is not hidden/covered. The area of the person who is not hidden/covered may be, for example, a face area of the person, an upper body area of the person including the face, and a torso area from the shoulder to the waist of the person. That is, the attribute may be the ReID feature quantity extraction area. Furthermore, for example, the attribute may be whether or not a person holds baggage. For example, the attribute may be determined in response to whether or not the baggage is included in the image together with the person. For example, the attribute may be brightness of the area of the person. The plurality of predetermined attributes may be, for example, an amount of light of the area of the person.

### [4-4: Technical Effect of Information Processing Apparatus 4]

Since the information processing apparatus 4 according to the fourth example embodiment associates the tracking target by using the ReID feature quantities of the plurality of attributes, it is possible to associate the tracking target with high accuracy.

### 5: Fifth Example Embodiment

An information processing apparatus, an information processing method, and a recording medium according to a fifth example embodiment will be described. The following describes the information processing apparatus, the information processing method, and the recording medium according to the fifth example embodiment, by using an information processing apparatus 4 to which the information processing apparatus, the information processing method, and the recording medium according to the fifth example embodiment are applied.

### [5-1: Configuration of Information Processing Apparatus 5]

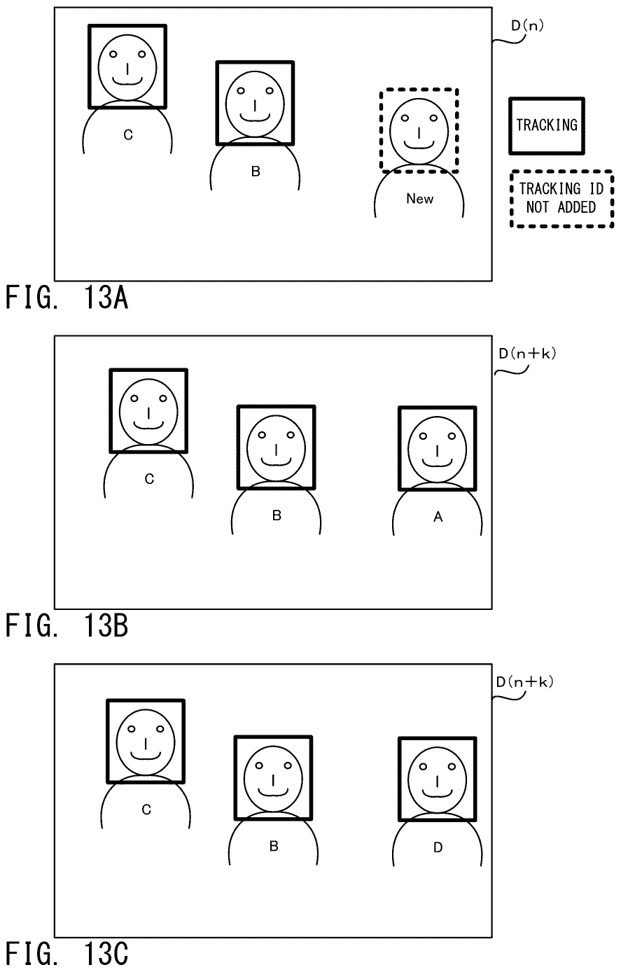

With reference to FIG. 12, a configuration of the information processing apparatus 5 according to the fifth example embodiment will be described. FIG. 12 is a block diagram illustrating the configuration of the information processing apparatus 5 according to the fifth example embodiment.

As illustrated in FIG. 12, the information processing apparatus 5 according to the fifth example embodiment is different from the information processing apparatus 2 according to the second example embodiment to the information processing apparatus 4 according to the fourth example embodiment, in that the arithmetic apparatus 21 includes a display control unit 517. Other features of the information processing apparatus 5 may be the same as those of at least one of the information processing apparatus 2 to the information processing apparatus 4. For this reason, a part that is different from each of the example embodiments described above will be described in detail below, and a description of the other overlapping parts will be omitted as appropriate.

### [5-2: Display Operation Performed by Information Processing Apparatus 5]

The fifth example embodiment may be an example embodiment for describing a specific example of an output operation of outputting a result of the information processing operation in the second example embodiment (i.e., the operation corresponding to the step S27 in FIG. 4). The information processing apparatus 5 according to the fifth example embodiment may update the output operation of outputting the result of the information processing operation at each time of processing one image.

In the fifth example embodiment, the output apparatus 25 may include a display apparatus (referred to as a “display D”) that is configured to display an image indicating the information that is desirably outputted. FIG. 13 illustrates a screen example of the result of the information processing operation displayed on the display D in the fifth example embodiment. The display D in the fifth example embodiment may display a screen for a person who manages the tracking area TA to confirm a tracking state. The display control unit 517 may control the display of the display D.

The display control unit 517 displays the image in which information indicating the tracking result on the image, is superimposed on the person in question included in the image. When the tracking of the person is successful, the display control unit 517 may display the image in which information indicating a success in the tracking is superimposed on the person included in the image. When the tracking of the person is failed, the display control unit 517 may display the image in which information indicating a failure in the tracking is superimposed on the person included in the image. The display control unit 517 may superimpose the tracking ID of the person, as the information indicating the success in the tracking. The case where the tracking of the person is failed, may be a state where there is no association with the person who is already being tracked, and may be a case where it is unknown whether the tracking target is new, i.e., a case where the ReID feature quantity is not extracted (in the case of the step S252: No).

FIG. 13(a) illustrates a display example of the tracking result based on an n-th acquired image. In the case illustrated in FIG. 13, the display control unit 517 may superimpose a rectangle in a thick solid line and the tracking ID on the person for whom the tracking is successful. The display control unit 517 may display the image in which a rectangle in a dashed line and “New” indicating that the ReID matching is not yet performed, are superimposed on the person for whom the tracking is failed. FIG. 13(a) illustrates that, in the n-th acquired image, the person with the tracking ID “B” and a person with a tracking ID “C” are being tracked, and that a person on whom the tracking ReID matching is not yet performed is captured.

FIG. 13(b) illustrates a display example of the tracking result based on an (n+k)-th acquired image. FIG. 13(b) illustrates that the person on whom the ReID matching is not yet performed in the information processing operation based on the n-th acquired image, has been tracked in the past and is determined to be the person with the tracking ID “A” in the information processing operation based on the (n+k)-th acquired image.

FIG. 13(c) illustrates a display example of the tracking result based on the (n+k)-th acquired image. FIG. 13(c) illustrates that the person on whom the ReID matching is not yet performed in the information processing operation based on the n-th acquired image, is determined to be a new tracking target and is provided with a tracking ID “D” in the information processing operation based on the (n+k)-th acquired image.

### [5-3: Technical Effect of Information Processing Apparatus 5]

The person who manages the tracking area TA is able to confirm the tracking state of each person in real time by visually recognizing the display D.

### 6: Supplementary Notes

With respect to the example embodiment described above, the following Supplementary Notes are further disclosed.

### [Supplementary Note 1]

An information processing apparatus including:
an acquisition unit that acquires an image;
a tracking unit that tracks a person included in the image; and
a registration updating unit that registers or updates feature information on a person who has been tracked by the tracking unit, and determines whether or not to register or update the feature information on the person, based on the image including the person.

### [Supplementary Note 2]

The information processing apparatus according to Supplementary Note 1, further including a matching unit that matches extracted feature information extracted from the person included in the image, with registered feature information, in a case where the person included in the image is not a person who is being tracked by the tracking unit, wherein
the registration updating unit includes:
   an association unit that associates the person included in the image with a person corresponding to the registered feature information, in response to a success in matching between the extracted feature information and the registered feature information by the matching unit;
   a registration unit that registers the extracted feature information in association with the person included in the image, in response to a failure in the matching between the extracted feature information and the registered feature information by the matching unit;
   a feature extraction determination unit that determines whether or not to extract the feature information on the person from the image, based on at least one of the image and information about the person registered, in a case where the person included in the image is a person who is being tracked by the tracking unit;
   an extraction unit that extracts the feature information on the person from the image, in response to a determination by the feature extraction determination unit to extract the feature information;
   an updating determination unit that determines whether or not to update the registered feature information on the person, based on at least one of the image, the information about the person registered, and the extracted feature information on the person extracted by the extraction unit; and
   an updating unit that updates the registered feature information on the person by using the extracted feature information on the person extracted by the extraction unit, in response to a determination by the updating determination unit to update the registered feature information.

### [Supplementary Note 3]

The information processing apparatus according to Supplementary Note 2, wherein the feature extraction determination unit determines whether or not to extract the feature information on a person in question, based on a number of images including the person in question who is being tracked by the tracking unit.

### [Supplementary Note 4]

The information processing apparatus according to Supplementary Note 2, wherein
the information about the person registered includes a registered image in which the registered feature information is extracted, and
at least one of the feature extraction determination unit and the updating determination unit performs determination based on information indicating an overlap between a predetermined joint part of the person in the registered image and a predetermined joint part of the person in the image.

### [Supplementary Note 5]

The information processing apparatus according to Supplementary Note 2, wherein
the information about the person registered includes an evaluation value obtained by evaluating the registered feature information on the person in question, and
at least one of the feature extraction determination unit and the updating determination unit performs determination based on the evaluation value.

### [Supplementary Note 6]

The information processing apparatus according to Supplementary Note 2, wherein the updating determination unit evaluates the extracted feature information based on a result of the matching between the extracted feature information and the registered feature information, and determines whether or not to update the registered feature information.

### [Supplementary Note 7]

The information processing apparatus according to Supplementary Note 2, wherein the updating determination unit evaluates the extracted feature information and determines whether or not to update the registered feature information, based on at least one of:
information indicating an overlap between first predetermined areas of the person in different images; and
information indicating an overlap between second predetermined areas of different persons in the same image.

### [Supplementary Note 8]

The information processing apparatus according to Supplementary Note 2, further including a personal matching unit that collects biometric information on the person included in the image and matches the biometric information with registered biometric information, wherein
the association unit associates the person included in the image with a person corresponding to the registered biometric information, in response to a success in matching by the personal matching unit.

### [Supplementary Note 9]

The information processing apparatus according to claim 2, further including an additional determination unit that determines to which of a plurality of predetermined attributes the person included in the image corresponds, and determines whether or not feature information corresponding to an attribute in question is registered, wherein
the registration unit registers the feature information corresponding to the attribute in question, in response to a determination by the additional determination unit that the feature information corresponding to the attribute in question is not registered, and
the updating determination unit determines whether or not to update the registered feature information on the person, in response to a determination by the additional determination unit that the feature information corresponding to the attribute in question is registered.

### [Supplementary Note 10]

The information processing apparatus according to Supplementary Note 1 or 2, further including a display unit that displays the image in which information indicating a tracking result is superimposed on a person in question included in the image.

### [Supplementary Note 11]

An information processing method including:
acquiring an image;
tracking a person included in the image; and
determining whether or not to register or update feature information on the person, based on the image including the person, and registering or updating the feature information on a person who has been tracked.

### [Supplementary Note 12]

A recording medium on which a computer program that allows a computer to execute an information processing method is recorded, the information processing method including:
acquiring an image;
tracking a person included in the image; and
determining whether or not to register or update feature information on the person, based on the image including the person, and registering or updating the feature information on a person who has been tracked.

At least a part of the constituent components of each of the example embodiments described above can be combined with at least another part of the constituent components of each of the example embodiments described above, as appropriate. A part of the constituent components of each of the example embodiments described above may not be used.

Furthermore, to the extent permitted by law, all references cited in the disclosure (e.g., published publications) are hereby incorporated by reference, as a part of the description of this disclosure.

This disclosure is not limited to the examples described above. This disclosure is allowed to be changed, if desired, without departing from the essence or spirit of this disclosure which can be read from the claims and the entire identification. An information processing apparatus, an information processing method, and a recording medium with such changes are also intended to be within the technical scope of this disclosure.

### DESCRIPTION OF REFERENCE CODES

1, 2, 3, 4, 5 Information processing apparatus
11, 211 Acquisition unit
12, 212 Tracking unit
13, 213 Registration updating unit
2131 Association unit
2132 Registration unit
2133 Feature extraction determination unit
2134 Extraction unit
2135 Updating determination unit
2136 Updating unit
214 Matching unit
315 Personal matching unit
416 Additional determination unit
517 Display control unit
TA Tracking area
RIDB ReID feature quantity database
FC Facial feature quantity database

What is claimed is:

1. An information processing apparatus comprising:
at least one memory that is configured to store instructions; and
at least one processor that is configured to execute the instructions to:
acquire an image;
track a person included in the image; and
register or update feature information on a person who has been tracked, and determine whether or not to register or update the feature information on the person, based on the image including the person.

2. The information processing apparatus according to claim 1, wherein the at least one processor is configured to execute the instructions to:
match extracted feature information extracted from the person included in the image, with registered feature information, in a case where the person included in the image is not a person who is being tracked;
associate the person included in the image with a person corresponding to the registered feature information, in response to a success in matching between the extracted feature information and the registered feature information;
register the extracted feature information in association with the person included in the image, in response to a failure in the matching between the extracted feature information and the registered feature information;
determine whether or not to extract the feature information on the person from the image, based on at least one of the image and information about the person registered, in a case where the person included in the image is a person who is being tracked;
extract the feature information on the person from the image, in response to a determination by the feature extraction determination unit to extract the feature information;
determine whether or not to update the registered feature information on the person, based on at least one of the image, the information about the person registered, and the extracted feature information on the person extracted; and
update the registered feature information on the person by using the extracted feature information on the person extracted, in response to a determination to update the registered feature information.

3. The information processing apparatus according to claim 2, wherein the at least one processor is configured to execute the instructions to determine whether or not to extract the feature information on a person in question, based on a number of images including the person in question who is being tracked.

4. The information processing apparatus according to claim 2, wherein
the information about the person registered includes a registered image in which the registered feature information is extracted, and
the at least one processor is configured to execute the instructions to perform determination based on information indicating an overlap between a predetermined joint part of the person in the registered image and a predetermined joint part of the person in the image.

5. The information processing apparatus according to claim 2, wherein
the information about the person registered includes an evaluation value obtained by evaluating the registered feature information on the person in question, and
the at least one processor is configured to execute the instructions to perform determination based on the evaluation value.

6. The information processing apparatus according to claim 2, wherein the at least one processor is configured to execute the instructions to evaluate the extracted feature information based on a result of the matching between the extracted feature information and the registered feature information, and determines whether or not to update the registered feature information.

7. The information processing apparatus according to claim 2, wherein the at least one processor is configured to execute the instructions to evaluate the extracted feature information and determine whether or not to update the registered feature information, based on at least one of:
information indicating an overlap between first predetermined areas of the person in different images; and
information indicating an overlap between second predetermined areas of different persons in the same image.

8. The information processing apparatus according to claim 2, wherein the at least one processor is configured to execute the instructions to:
collect biometric information on the person included in the image and match the biometric information with registered biometric information; and
associate the person included in the image with a person corresponding to the registered biometric information, in response to a success in matching.

9. The information processing apparatus according to claim 2, wherein the at least one processor is configured to execute the instructions to:
determine to which of a plurality of predetermined attributes the person included in the image corresponds, and determine whether or not feature information corresponding to an attribute in question is registered;
register the feature information corresponding to the attribute in question, in response to a determination that the feature information corresponding to the attribute in question is not registered; and
determine whether or not to update the registered feature information on the person, in response to a determination that the feature information corresponding to the attribute in question is registered.

10. The information processing apparatus according to claim 1, wherein the at least one processor is configured to execute the instructions to display the image in which information indicating a tracking result is superimposed on a person in question included in the image.

11. An information processing method comprising:
acquiring an image;
tracking a person included in the image; and
determining whether or not to register or update feature information on the person, based on the image including the person, and registering or updating the feature information on a person who has been tracked.

12. A non-transitory recording medium on which a computer program that allows a computer to execute an information processing method is recorded, the information processing method including:
acquiring an image;
tracking a person included in the image; and
determining whether or not to register or update feature information on the person, based on the image including the person, and registering or updating the feature information on a person who has been tracked.
